(19) United States
(12) Patent Application Publication
(10) Pub. No.: US 2024/0430603 A1
(43) Pub. Date: Dec. 26, 2024

(54) CHARGER AND WIRELESS MICROPHONE FOR HEARING AID

(71) Applicant: Starkey Laboratories, Inc., Eden Prairie, MN (US)

(72) Inventors: Timothy P. Johnston, Los Gatos, CA (US); Ganesh Borra, Plymouth, MN (US); Josh Braband, Eden Prairie, MN (US)

(21) Appl. No.: 18/750,464

(22) Filed: Jun. 21, 2024

Related U.S. Application Data
(60) Provisional application No. 63/522,876, filed on Jun. 23, 2023.

(51) Int. Cl. H04R 1/10; H04R 1/02; H04R 25/00

(52) U.S. Cl. CPC H04R 1/1025; H04R 1/02; H04R 25/60; H04R 1/1016

(57) ABSTRACT

Embodiments herein relate to a hearing assistance system including a multi-function charging case for one or more ear-worn devices. The case can be placed in a streaming mode, in which first input audio is received by the case and streamed from the case to the ear-worn device. The case can be switched between different modes, including the streaming mode and a charging mode, using a user input device. Other embodiments are also included herein.

### RELATED APPLICATIONS

This application claims the benefit of U.S. Provisional Application No. 63/522,876, filed Jun. 23, 2023, the content of which is herein incorporated by reference in its entirety.

### TECHNICAL FIELD

Embodiments herein relate to ear-worn devices, such as hearing aids, configured for wireless communication.

### BACKGROUND OF THE INVENTION

Ear-worn devices are configured to provide audio input to the ears of a user. Some examples of hearing devices are headsets, hearing aids, speakers, cochlear implants, bone conduction devices, and personal listening devices. Hearing devices often include a rechargeable battery that can be recharged and can be configured for wireless communication with one or more external audio sources.

### SUMMARY OF THE INVENTION

In a first aspect, a hearing assistance system can be included having a first ear-worn device, which can include a device speaker, a device microphone, a device processor, a device non-transitory computer memory, a device rechargeable battery, and a device wireless communication component. The hearing assistance system can further include a case configured to charge the device rechargeable battery of the first ear-worn device. The case can include a first case charging structure for charging the device rechargeable battery of the first ear-worn device, a case rechargeable battery, a second case charging structure for charging the case rechargeable battery, a case processor, a case non-transitory computer memory, a first case microphone, a first case interface port, and a case wireless communication device. The hearing assistance system further comprises an input device configured to provide an input signal to the case processor. The case non-transitory computer memory stores computer instructions for: upon receiving a first signal from the input device, placing the case in a streaming mode, in which first input audio can be received by the case and streamed from the case wireless communication device to the device wireless communication component of the first ear-worn device, and placing the case in a charging mode, in which first ear-worn device can be charged by the first case charging structure upon being received by the case.

In a second aspect, in addition to one or more of the preceding or following aspects, or in the alternative to some aspects, the first input audio can be received by the case through the first case microphone.

In a third aspect, in addition to one or more of the preceding or following aspects, or in the alternative to some aspects, the first input audio can be received by the case from a device electrically connected to the first case interface port.

In a fourth aspect, in addition to one or more of the preceding or following aspects, or in the alternative to some aspects, the second case charging structure includes the first case interface port, wherein the first case interface port includes electrical contacts for interfacing with a power supply to charge the case rechargeable battery.

In a fifth aspect, in addition to one or more of the preceding or following aspects, or in the alternative to some aspects, the case further includes a second case interface port configured to receive the first input audio from an auxiliary device electrically connected to the second case interface port.

In a sixth aspect, in addition to one or more of the preceding or following aspects, or in the alternative to some aspects, the first input audio can be received by the case wireless communication device from an auxiliary device.

In a seventh aspect, in addition to one or more of the preceding or following aspects, or in the alternative to some aspects, the first ear-worn device can be configured to be worn by a first user, the hearing assistance system further can include a second ear-worn device configured to be worn by a second user, wherein when the case can be in the streaming mode, the first input audio can be streamed from the case to the first ear-worn device and to the second ear-worn device.

In an eighth aspect, in addition to one or more of the preceding or following aspects, or in the alternative to some aspects, the case can include a streaming circuit board, which can include the first case microphone and the first case interface port.

In a ninth aspect, in addition to one or more of the preceding or following aspects, or in the alternative to some aspects, the case can include a power circuit board, wherein the power circuit board can be physically separate from the streaming circuit board and the power circuit board can include the case battery and the case charging structure.

In a tenth aspect, in addition to one or more of the preceding or following aspects, or in the alternative to some aspects, the streaming circuit board of the hearing assistance system can further include a front microphone disposed on a front portion of the streaming circuit board corresponding to a front side of the case, a rear microphone disposed on a rear portion of the streaming circuit board corresponding to the rear side of the case, a left microphone disposed on a left portion of the streaming circuit board corresponding to a left side of the case, and a right microphone disposed on a right portion of the streaming circuit board corresponding to a right side of the case.

In an eleventh aspect, in addition to one or more of the preceding or following aspects, or in the alternative to some aspects, the first ear-worn device further includes the input device.

In a twelfth aspect, in addition to one or more of the preceding or following aspects, or in the alternative to some aspects, the case further includes the input device.

In a thirteenth aspect, in addition to one or more of the preceding or following aspects, or in the alternative to some aspects, the input device can be physically separate from the first ear-worn device and from the case.

In a fourteenth aspect, in addition to one or more of the preceding or following aspects, or in the alternative to some aspects, the case wireless communication device communicates at a frequency of 900 MHz, 2.4G or 5G.

In a fifteenth aspect, in addition to one or more of the preceding or following aspects, or in the alternative to some aspects, the case wireless communication device can be configured to communicate with a mobile device.

In a sixteenth aspect, a hearing assistance system includes a first ear-worn device, which can include a device speaker, a device microphone, a device processor, a device non-transitory computer memory, a device rechargeable battery, and a device wireless communication component. The hearing assistance system can further include a case configured to charge the device rechargeable battery of the first ear-worn device. The case can include a first case charging structure for charging the device rechargeable battery of the first ear-worn device, a case rechargeable battery, a second case charging structure for charging the case rechargeable battery, a case processor, a case non-transitory computer memory, a first case microphone, a first case interface port, and a case wireless communication device. The hearing assistance system further comprises an input device configured to provide an input signal to the case processor, wherein the case non-transitory computer memory stores computer instructions for: upon receiving a first signal from the input device, placing the case in a streaming mode, in which first input audio can be received by the case and streamed from the case wireless communication device to the device wireless communication component of the first ear-worn device, and upon receiving a second signal from the input device, placing the case in a charging mode, in which first ear-worn device can be charged by the first case charging structure upon being received by the case.

In a seventeenth aspect, a method of streaming audio to an ear-worn device from a case, the ear-worn device can include a device wireless communication device, a rechargeable battery, and a device charging structure and the case can include a case wireless communication device, a case charging structure and a case rechargeable battery. The method can include sending a first signal from an input device to the case, upon receiving the first signal, placing the case in a streaming mode, receiving audio from a source at an audio input of the case. The method can further include streaming the audio from the case wireless communication device to the device wireless communication device.

In an eighteenth aspect, in addition to one or more of the preceding or following aspects, or in the alternative to some aspects, the ear-worn device can be configured to be worn by a first user, the method further can include streaming the audio from the case wireless communication device to a second device wireless communication device of a second ear-worn device configured to be worn by a second user.

In a nineteenth aspect, in addition to one or more of the preceding or following aspects, or in the alternative to some aspects, the method can include: positioning the ear-worn device inside the case such that the device charging structure can be in electrical communication with the case charging structure; sending a second signal from the input device to the case; upon receiving a second signal from the input device, placing the case in a charging mode; and charging the rechargeable battery of the ear-worn device with the case charging structure.

In a twentieth aspect, in addition to one or more of the preceding or following aspects, or in the alternative to some aspects, the audio input of the case can include a microphone. This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a perspective view of a hearing assistance system in accordance with various embodiments herein.

FIG. 2 is a perspective view of a case in accordance with various embodiments herein.

FIG. 3 is a perspective view of a case subassembly of the case of FIG. 2 in accordance with various embodiments herein.

FIG. 4 is a front view of the case subassembly of FIG. 3 in accordance with various embodiments herein.

FIG. 5 is a side view of the case of FIG. 2 in accordance with various embodiments herein.

FIG. 6 is a rear view of the case of FIG. 2 in accordance with various embodiments herein.

FIG. 7 is a top view of the case subassembly of FIG. 3 in accordance with various embodiments herein.

FIG. 8 is a schematic view of one embodiment of a case in accordance with various embodiments herein.

FIG. 9 is a perspective view of an ear-worn device in accordance with various embodiments herein.

FIG. 10 is a schematic block diagram of an ear-worn device in accordance with various embodiments herein.

FIG. 11 is a method of streaming audio to an ear-worn device in accordance with various embodiments herein.

FIG. 12 is a method of charging an ear-worn device inside the case in accordance with various embodiments herein.

FIG. 13 is a schematic view of an ear-worn device user within an environment in accordance with various embodiments herein.

FIG. 14 is a schematic view is shown of a plurality of ear-worn device users within an environment in accordance with various embodiments herein.

FIG. 15 is a schematic view of an alternative embodiment of a case in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

Embodiments herein relate to a hearing assistance system having a multi-functional case configured to charge one or more ear-worn devices and stream audio to the ear-worn devices. The hearing assistance system may include one or more ear-worn devices, each ear-worn device having a device rechargeable battery and a device wireless communication component. The hearing assistance system may include a case configured to charge the device rechargeable battery of each of the ear-worn devices. The case may include a case charging structure for charging the device rechargeable battery of the first ear-worn device, at least one interface port, and a case wireless communication device.

The hearing assistance system may further include an input device configured to provide an input signal to the case. Upon receiving a first signal from the input device the case may be placed into a streaming mode, in which audio is streamed from the case to the one or more ear-worn devices. Upon receiving a second signal from the input device, the case may be placed into a charging mode, in which the ear-worn devices are charged by the first case charging structure upon being received by the case. The combined charging and streaming functionality of the case enables ear-worn device users to experience the benefit of multiple accessories in a convenient and compact manner.

The input device may be integrated into one ear-worn device, two ear-worn devices, the case, a physically separate device from both the ear-worn devices and the case, or in a combination of these locations. In some embodiments, the input device is a button on the exterior surface of the case. In addition, or alternatively, an input device can be provided as a button on an exterior surface of the ear-worn device. The input device allows the user to engage the streaming mode of the case.

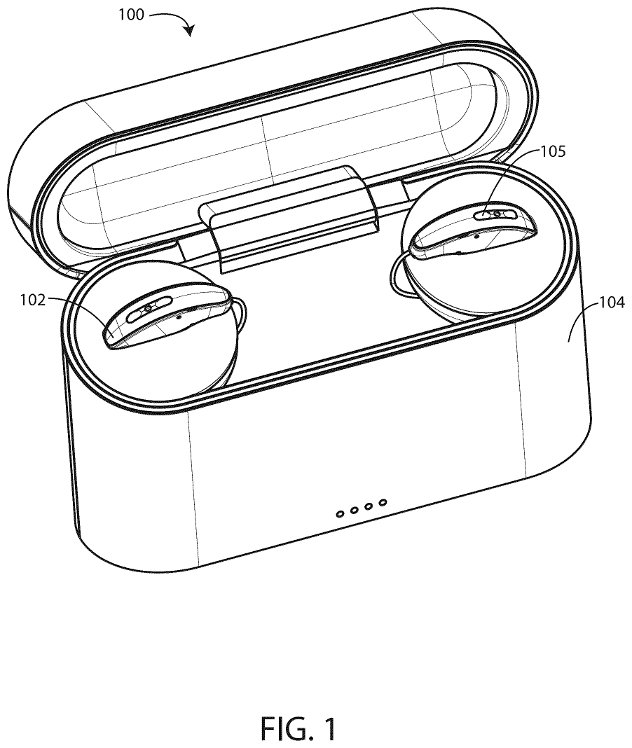

### Hearing Assistance System (FIG. 1)

Referring now to FIG. 1, a perspective view of a hearing assistance system is shown in accordance with various embodiments herein. The hearing assistance system 100 can include at least one ear-worn device 102 and a case 104. In various embodiments, each ear-worn device 102 contains a rechargeable battery and is configured to be positioned within the case so that a charging structure of the ear-worn device 102 sits adjacent a case charging structure within the case 104 such that the rechargeable battery can be recharged by the charging case.

In the example of FIG. 1, the hearing assistance system 100 includes two ear-worn devices 102. However, in some embodiments, the hearing assistance system 100 may include a single ear-worn device 102 and in some embodiments, the hearing assistance system 100 may include three or more ear-worn devices 102.

The term “ear-worn device” as used herein shall refer to devices that can aid a person with impaired hearing. The term “ear-worn device” shall also refer to devices that can produce optimized or processed sound for persons with normal hearing. Hearing aid assemblies herein can include hearables (e.g., wearable earphones, headphones, earbuds, virtual reality headsets), hearing aids (e.g., hearing instruments), cochlear implants, and bone-conduction devices, for example. Hearing aid assemblies include, but are not limited to, behind-the-ear (BTE), in-the ear (ITE), in-the-canal (ITC), invisible-in-canal (IIC), receiver-in-canal (RIC), receiver in-the-ear (RITE) or completely-in-the-canal (CIC) type hearing aid assemblies or some combination of the above. In some embodiments, the hearing aid assemblies may comprise a contralateral routing of signal (CROS) or bilateral microphones with contralateral routing of signal (BiCROS) amplification system. In some embodiments herein, an ear-worn device may also take the form of a piece of jewelry, including the frames of glasses, which may be attached to the head on or about the ear. The structures and components described herein can also be used in an ear-wearable device that is not a hearing assistance device, such as a medical monitoring device.

In various embodiments, the hearing assistance system 100 can further include an input device 105. The input device may be integrated into one ear-worn device, two ear-worn devices 102, the case 104, or a combination of these. Additionally, or alternatively, the input device 105 may be a physically separate device from both the ear-worn devices 102 and the case 104. In the example of FIG. 1, the input device 105 is disposed on a top portion of the ear-worn device 102, but other placements of the input device are possible. In various embodiments, the input device 105 can have or include one or more buttons, switches, or the like, such as a first button and a second button. For example, a volume up button and a volume down button can be included in the input device. In various embodiments the hearing aid user can interact with the input device 105 (e.g., by pressing one or more buttons) to adjust the volume, change one or more settings, control an accessory device (e.g., the case 104), or turn the ear-worn device on or off.

In various embodiments, the input device 105 is configured to provide an input signal to a processor of the case 104. In one example, upon receiving a first signal from the input device 105, the case 104 is placed into a streaming mode. While in the streaming mode, the case 104 is configured to receive audio input from an external source and stream the audio to one or more ear-worn devices 102.

In some embodiments, the case 104 may stream audio to one or more ear-worn devices 102 worn by a single user. In some embodiments, the case 104 may stream audio to ear-worn devices 102 worn by multiple users. In one example, a first ear-worn device is configured to be worn by a first user and a second ear-worn device configured to be worn by a second user and the audio is streamed from the case 104 to the first ear-worn device and to the second ear-worn device. In one example, the audio is streamed from the case 104 to a first ear-worn device worn by a first user and to a second ear-worn device worn by a second user. In one example, the audio is further streamed from the case 104 to a third ear-worn device configured to be worn or worn by a third user. In one example, the audio is further streamed from the case 104 to a fourth ear-worn device configured to be worn or worn by a fourth user. However, it should be understood that the case 104 is capable of streaming audio to any number of ear-worn devices associated with any number of users.

In various embodiments, the input device 105 is configured to provide multiple inputs signals to the case processor. In an embodiment, upon receiving a second signal from the input device 105, the case 104 is placed in a charging mode. While in the charging mode the one or more ear-worn devices 102 are charged by one or more charging structures of the case.

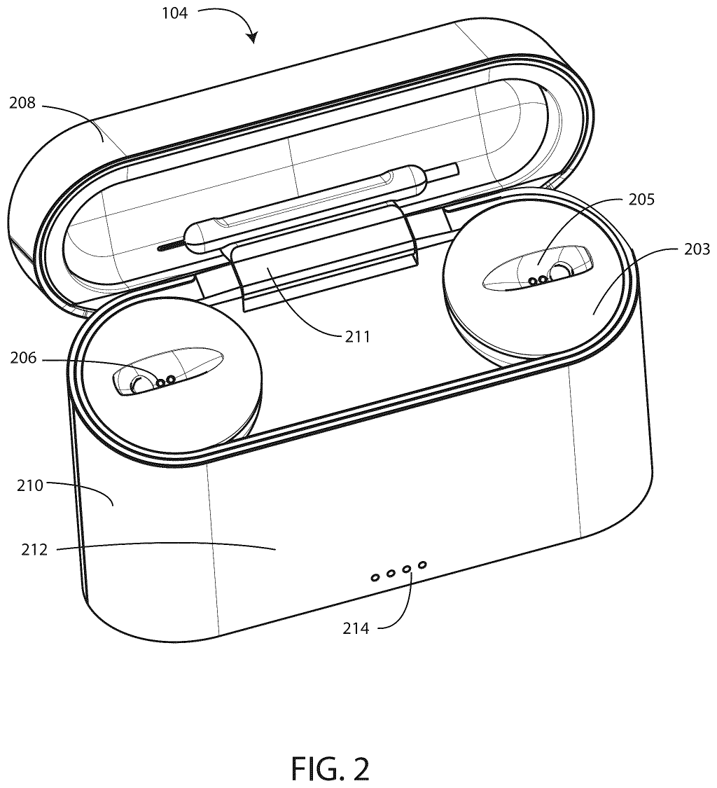

### Multifunction Case (FIGS. 2-7)

Referring now to FIG. 2, a perspective view of a case is shown in accordance with various embodiments herein. Embodiments of the case 104 are directed to storing, protecting, and charging ear-worn device(s) 102 contained within the case. In various embodiments, the case 104 may be configured to move between an open position and a closed position. The case may be sized to be easily held in a human hand, easily held in a typical pocket of clothing, and easily transported. As a result of the ease of transportation, a user is more likely to bring the case along with the user when away from home or even within the home. A safe place for storing the ear-worn devices and the ability to charge the hearing aids is therefore more likely to be close at hand to the user. In various embodiments, the case may be opened and closed with a single human hand.

In various embodiments, the case 104 can have an interior top surface 203 and one or more indentations 205 defined in the interior top surface 203. Each indentation 205 is configured to receive an ear-worn device 102. In various embodiments, each indentation 205 is shaped to be a negative of a portion of the ear-worn device 102, such that the ear-worn device is configured to sit flush with the indentation when placed in the case 104. Each indentation 205 includes a case charging structure 206 for charging a rechargeable battery of an ear-worn device. In the embodiment of FIG. 2, the case 104 has two indentations 205 configured to accommodate two ear-worn devices 102 at a given time. However, a case 104 can include any suitable number of indentations 205 to accommodate the devices of a hearing assistance system 100, such as a single indentation, three indentations, four indentations, or more indentations.

The case can have a case main body 210 and a lid 208. The case main body 210 may further include a case battery 212 and case electronics configured to charge one or more ear-worn devices 102 among other optional functions. The case main body 210 may be connected to the lid 208 by a hinge 211 such that the lid can move the case between an open and closed position.

In various examples, the case 104 may be configured or adapted such that the ear-worn devices 102 contained within the case are charging when the case is in a closed position, and, for example, not charging when the case is in the open position. Specifically, the case may include one or more contact points that interact with one another when the case is in the closed position to charge the ear-worn devices. As such, a user knows that the ear-worn devices contained within the case are charging when the case is in a closed position. In one or more embodiments, the case may also be configured or adapted such that the ear-worn devices contained within the case may charge when the case is in the open position

In various embodiments, the case 104 may include case display 214 to provide a visual indicator regarding the status of components within the case 104. For example, the case display 214 may communicate the power level/status of the ear-worn devices or the case battery 212 contained within the case 104. Additionally, or alternatively, the case display may be indicative of a mode (e.g., charging mode, streaming mode, standby mode) of the case at a moment in time. In an exemplary embodiment, the display can include one or more LEDs. Alternatively, or in addition, the display 214 can include screen, touch screen, or other type of display device.

The case display 214 may be located anywhere on the case 104, including the case main body 210, the interior top surface 203 of the case main body, another interior surface of the case main body, an outer surface of the case main body, the lid 208, an inner surface of the lid 208, or an outer surface of the lid 208.

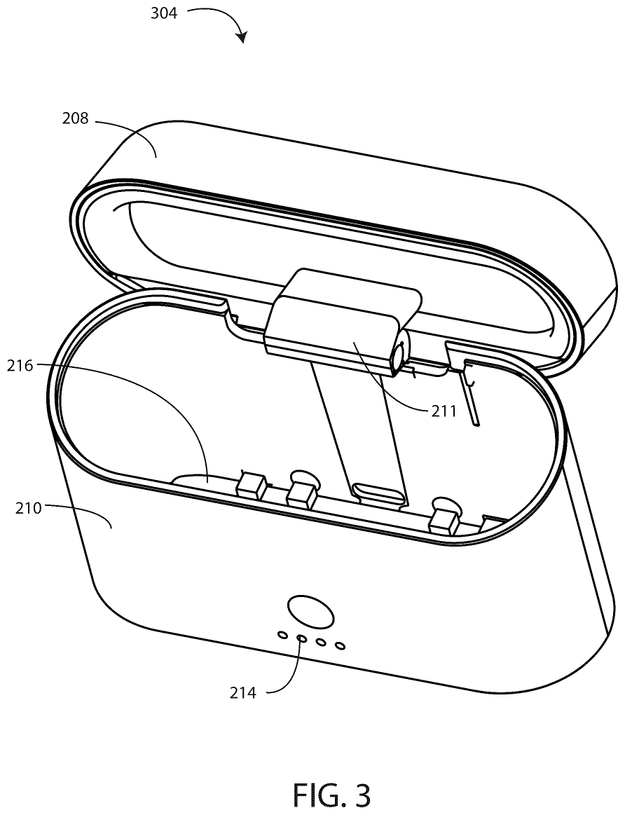

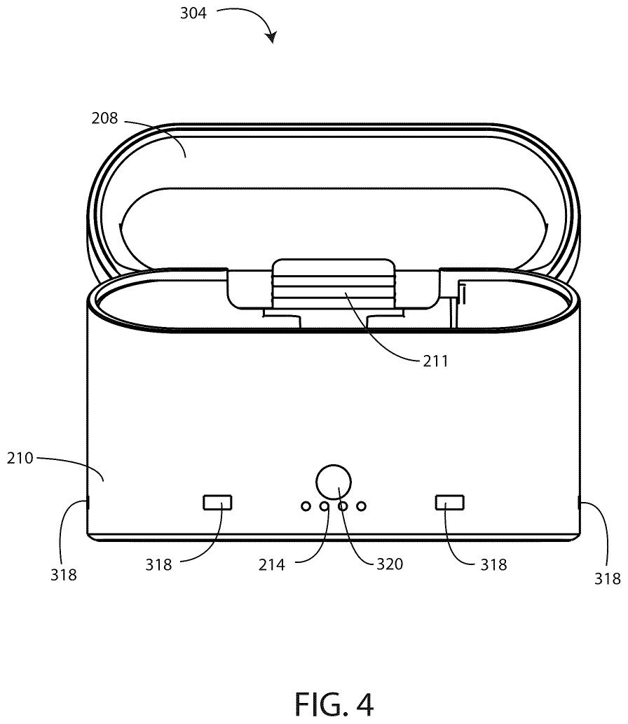

FIGS. 3-4 show various views of a case subassembly without various components (including the charging structures, case battery, and some of the case electronics) of case 104. Referring now to FIG. 3, a perspective view of a case subassembly 304 is shown in accordance with various embodiments herein. The case subassembly 304 includes the case main body 210 and the lid 208 connected by the hinge 211. Portions of a first circuit board 216 are visible on the bottom surface of the case subassembly 304.

Referring now to FIG. 4, a front view of the case subassembly 304 of FIG. 3 is shown in accordance with various embodiments herein. The case subassembly 304 includes the case display 214, two microphone ports 318, and the speaker 320 disposed on the front of the case.

It is to be understood as used herein that a “microphone port” can include any hole, cavity, depression, and/or groove that provides a pathway for sound to travel from the environment to a microphone disposed in the housing of the case 104. In the example of FIG. 3, the case subassembly 304 has two microphone ports 318 disposed on opposite sides of a lateral center of the case with each microphone port leading to a microphone housed on the first circuit board 216. However, case 104 can include any suitable number of microphone ports 318 disposed on the case such as a single microphone port, two microphone ports, three microphone ports, four microphone ports, five microphone ports, six microphone ports, seven microphone ports, eight microphone ports, and a range of microphone ports up to, below, or between any of the previous numbers. Further the microphone ports may be disposed anywhere on the case 104, including the case main body, the lid 208, or both.

The case 104 may further include a speaker 320 adjacent to a speaker opening in the case 104. It is to be understood as used herein that a “speaker” can include any device capable of converting electrical energy into acoustical signal energy that is radiated into a space adjacent to the speaker such as a room or open air. The speaker 320 is configured to receive audio input from a case microphone and/or an external device (e.g., a television or computer) connected to a case interface port and broadcast the input audio to the surrounding space. The speaker may further broadcast sound files stored in a memory of the case. Examples of sound files include instructions for charging the ear-worn devices, instructions for donning the ear-worn device, instructions for adjusting settings of the ear-worn device, or a tone indicating that the ear-worn devices are fully charged.

In the example of FIG. 4, the case 104 has a single speaker 320 disposed at the lateral center of the case leading to a speaker component housed on the first circuit board 216. However, case 104 can include any suitable number of speakers disposed on case such as two, three, four, or more speakers. Further the speaker or speakers 320 may be disposed anywhere on the case 104, including the case main body 210 and/or the lid 208. In one example, the case 104 has two speakers 320 disposed on opposite sides of a lateral center of the case. In one example, the case 104 has two speakers 320 disposed on opposite sides of a medial center of the case. Further the microphone ports may be disposed anywhere on the case 104, including the case main body, the lid 208, or both.

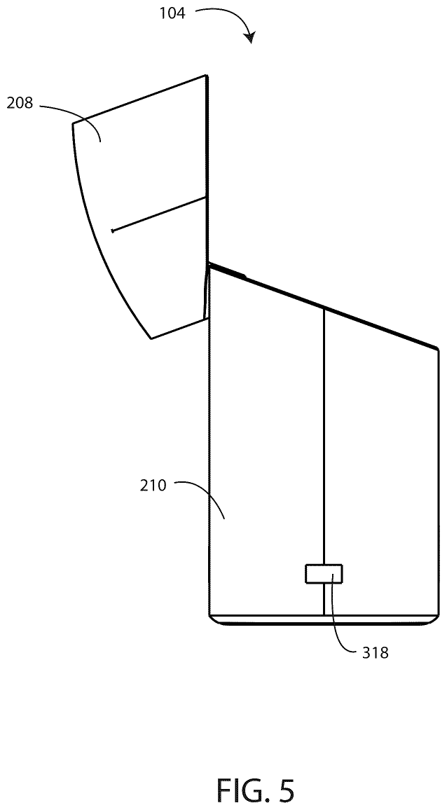

Referring now to FIG. 5, a side view of the case of FIG. 3 is shown in accordance with various embodiments herein. In the example of FIG. 5, the case 104 has a single microphone port 318 disposed on the side of the case leading to a microphone housed on the first circuit board 216. However, case 104 can include any suitable number of microphone ports 318 disposed on the side of the case such as two, three, or more microphone ports. Further the microphone ports may be disposed anywhere on the case 104, including the case main body and/or the lid 208.

In various embodiments, the two opposing left and right sides of the case 104 are substantially mirror images. The two opposing sides of the case may house the same components. In the example of the figures, both opposing sides of the case 104 house a single microphone port 318. Alternatively, the two opposing sides of the case 104 may house a different number and/or configuration of components.

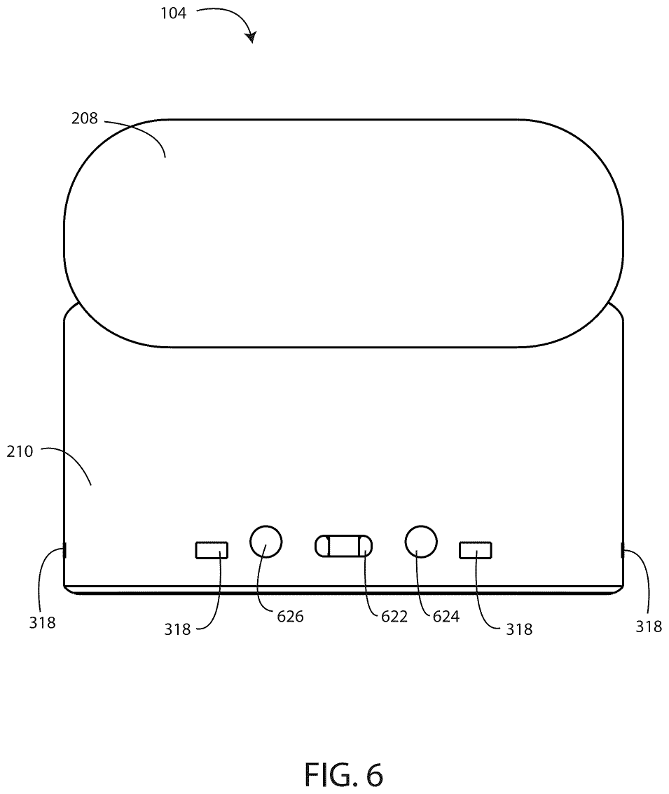

Referring now to FIG. 6, a rear view of the case of FIG. 3 is shown in accordance with various embodiments herein. The case 104 further includes a microphone port 318, a first interface port 622, a second interface port 624, and a user input device 626.

The first interface port 622 may include a charging structure configured to charge the case battery 212. A charging cord may connect the case battery 212 to an external power supply (e.g., a wall outlet) via the first interface port 622. The first interface port 622 can be any port suitable for charging the case battery 212. Additionally, or alternatively, the first interface port may also be configured to connect the case 104 to an auxiliary device, such that the case may receive input audio from the auxiliary device via the first interface port. Examples of configurations for the first interface port include, but are not limited to USB-A ports, USB-B ports, USB-C ports, Lightening ports, mini-USB ports, micro-USB ports, or the like.

The case 104 may further include a second interface port 624 configured to connect the case 104 to an auxiliary device, such that the case may receive input audio from the auxiliary device. In various embodiments, the second interface port 624 may be any suitable type of port such as including, but not limited to 3.5 mm jack ports, XLR ports, RCA ports, or the like.

In the example of FIG. 6, the rear side of the case 104 has two interface ports 622, 624 disposed on opposite sides of a lateral center of the case with each interface port leading to a component housed on the first circuit board 216. However, case 104 can include any suitable number of interface ports such as a single interface port or three or more interface ports. The case may include multiple of the same type of interface port or two or more different types of interface port disposed anywhere on the case 104, including the case main body 210, the lid 208, or both.

In the example of FIG. 6, the rear side of the case 104 has two microphone ports 318 disposed on opposite sides of a lateral center of the case with each microphone port leading to a microphone housed on the first circuit board 216. However, the rear side of the case 104 can include any suitable number of microphone ports 318 such as a single microphone port or three or more microphone ports. Further the microphone ports may be disposed anywhere on the case 104, including the case main body, the lid 208, or both.

The case 104 can further include an input device 626. In the example of FIG. 6, the user input is a single button disposed on the back side of the case. However, the input device 626 may take any suitable form such as one or more buttons, switches, a touch screen, or the like. In various embodiments the hearing aid user can interact with the input device 626 to turn the case on or off, select or change the operating mode of the case 104, or both. The case can include any suitable number of input devices disposed anywhere on the case 104, including the case main body 210 and/or the lid 208.

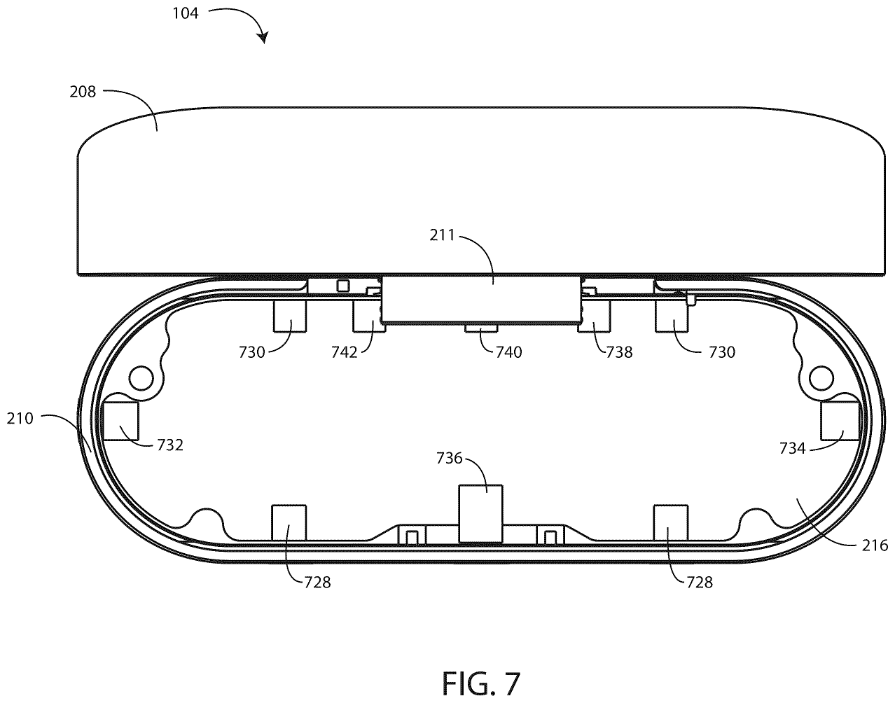

Referring now to FIG. 7, a top view of the case subassembly of FIG. 3 is shown in accordance with various embodiments herein. The case subassembly may further include a first circuit board 216. The first circuit board 216 can house any number of components used for streaming audio from the case 104 to one or more ear-worn devices 102. In the example of FIG. 7, the first circuit board includes a plurality of microphone components 728, 730, 732, 734, a speaker component 736, a user input component 738, first case interface port component 740, and second case interface port component 742.

In some embodiments, the first circuit board 216 may include a single microphone. In some embodiments, the first circuit board 216 may include greater than or equal to one, two, three, four, five, six, seven, or eight microphones, or can be an amount falling within a range between any of the foregoing. In the example of FIG. 7, first circuit board 216 includes two front microphone components 728 disposed on a front portion of the first circuit board corresponding to the microphone ports 318 disposed on front side of the case visible in FIG. 4. In the example of FIG. 7, the first circuit board 216 further includes two rear microphone components 730 disposed on a rear portion of the first circuit board corresponding to the microphone ports 318 disposed rear side of the case visible in FIG. 6. In the example of FIG. 7, the first circuit board 216 further includes a left microphone component 732 disposed on a left portion of the first circuit board corresponding to the microphone port 318 disposed left side of the case visible in FIG. 5. In the example of FIG. 7, the first circuit board 216 further includes a right microphone component 734 disposed on a right portion of the first circuit board corresponding to the microphone port 318 disposed right side of the case visible in FIG. 5.

In various embodiments, the case 104 is configured to broadcast the audio received by the microphones through the speaker 320 or stream the audio received by the microphones to one or more ear-worn devices 102. If the signal is streamed, the microphone signal can be processed by the ear-worn devices in a multitude of functions including but not limited to amplifying all received sound in the area, amplifying select sounds in an area, or aiding in active noise cancellation.

Incorporating multiple microphones on the first circuit board 216 of the case 104 offers several benefits, including increased sensitivity to sound. Moreover, incorporating multiple microphone ports orientated in different directions effectively turns the case into a directional microphone. Directional microphones tend to be more sensitive to picking up sounds in certain directions and are able to more effectively filter out background noise. By receiving audio input from ports on multiple sides of the case, sounds that come from both sides, which is most often background buzz, cancel each other out and allow the listener to concentrate on sounds coming from one direction. In one example, an ear-wearable device user may place the case 104 near one or more companions in a noisy environment. The audio will be received by the multiple microphones of the case and a processor of the case may filter out the background noise and transmit the filtered audio to the ear-worn device wearer.

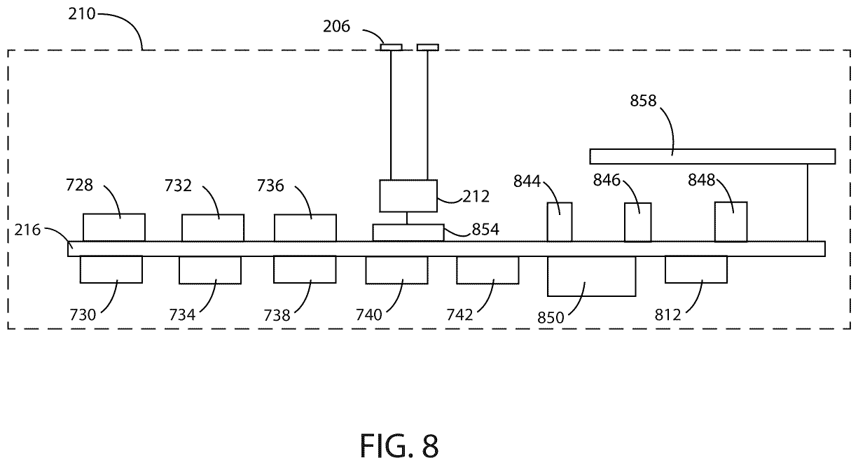

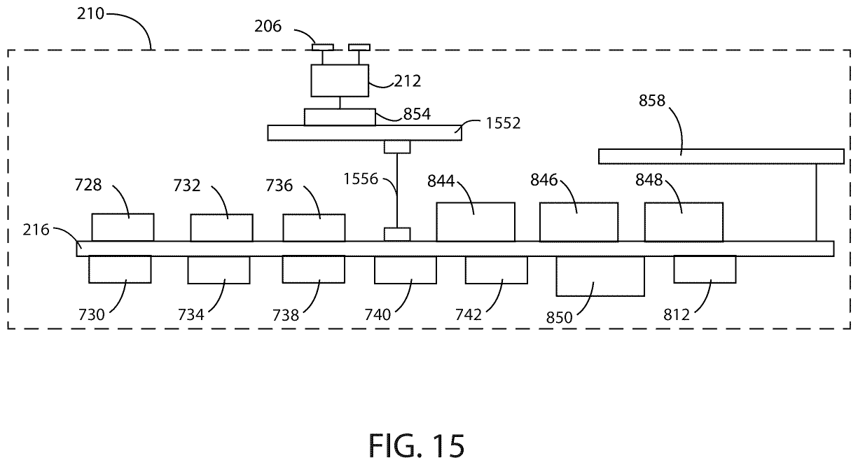

### Circuit Board Layout Examples (FIG. 8 and FIG. 15)

FIG. 8 is a schematic view of one embodiment of a case. The block diagram of FIG. 8 represents a generic case device for purposes of illustration. It will be appreciated, that cases herein can include a greater or lesser number of components than that shown in FIG. 8.

In various embodiments, the case 104, a case processor 844, a case sensor package 846, a case control circuit 848, and a case non-transitory computer memory 850, which are each can be connected to first circuit board 216. The case control circuit 848 can include various components including, but not limited to, a microprocessor, a microcontroller, an FPGA (field-programmable gate array) processing device, an ASIC (application specific integrated circuit), or the like. The case non-transitory computer memory 850 can include both volatile and non-volatile memory. The case non-transitory computer memory 850 can include ROM, RAM, flash memory, EEPROM, SSD devices, NAND chips, and the like. The case non-transitory computer memory 850 can be used to store data from sensors as described herein, store processed data generated using data from sensors as described herein, provide both functions, and also serve additional functions.

The first circuit board 216 further includes a plurality of microphone components 728, 730, 732, 734, a speaker component 736, a user input component 738, first case interface port component 740, and second case interface port component 742. The case 104 may further include a case wireless communications device 858 coupled to the coupled to the first circuit board 216. The case wireless communications device 858 can be a BLUETOOTH® transceiver, such as a BLE (BLUETOOTH® low energy) transceiver or other transceiver (e.g., an IEEE 802.11 compliant device).

The case 104 further comprises a case battery 212 electrically connected to power supply circuit 854, configured to provide power to the various components of the case 104. One or more charging contacts of case charging structure 206 are connected to the case battery 212 and are configured to interface with the charging contacts of one or more ear-worn devices 102.

The schematic example of FIG. 8 has been described as including a first circuit board where the electronics components of the case 104 are located. However, the electrical components of the case may be housed on any suitable number and configuration of circuit boards, such as two circuit boards, three circuit boards, four circuit boards, or more circuit boards. The electrical components can be divided by function between multiple circuit boards. In one alternative example shown in FIG. 15, the electrical components of the case are housed on two circuit boards: the first circuit board 216 and a power circuit board 1552. Now referring to FIG. 15, the power circuit board 1552 can include a case battery 212 electrically connected to power supply circuit 854, configured to provide power to the various components of the case 104.

The first circuit board 216 can also be referred to as the streaming circuit board in the embodiment of FIG. 15. The streaming circuit board can include the electronic components other than the power supply circuit 854, such as the microphone components and wireless communication device 858 used for streaming.

In the example of FIG. 15, the power circuit board 1552 is physically separate from the streaming circuit board 216. In various embodiments, the power circuit board 1552 may be electrically connected to the streaming circuit board 216 via one or more electrical connectors 1556. Such electrical connectors may include ribbon cables or wires soldered to each PCBA, a wire harness, ribbon cables attaching to a ZIF style connector, board to board rigid mount connectors, or the like.

The case electronics may be implemented, at least in part, in hardware, software, firmware, or any combination thereof. For example, various aspects of the techniques may be implemented within one or more processors, including one or more microprocessors, microcontrollers, DSPs, ASICs, FPGAs, or any other equivalent integrated or discrete logic circuitry, as well as any combinations of such components, or other devices. The term “processor” or “processing circuitry” may generally refer to any of the foregoing logic circuitry, alone or in combination with other logic circuitry, or any other equivalent circuitry. Such hardware, software, and/or firmware may be implemented within the same system or within separate systems to support the various operations and functions described in this disclosure. In addition, any of the described components may be implemented together or separately as discrete but interoperable logic devices.

### Ear-Worn Devices

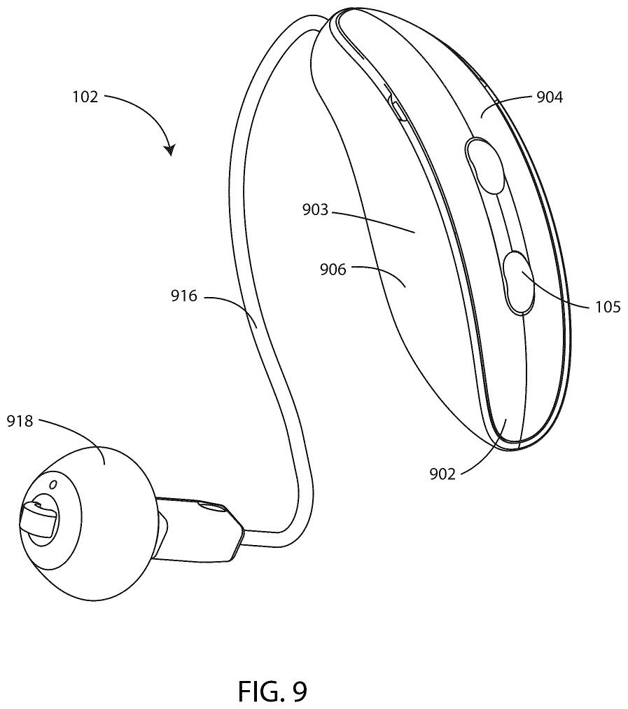

Referring now to FIG. 9, a perspective view of an ear-worn device is shown in accordance with various embodiments herein. The ear-worn device 102 in the embodiment of FIG. 9 is a behind-the-ear (BTE) type device and thus the components are housed behind the ear with a cable leading to an earbud designed to be placed within an ear canal of a wearer. The ear-worn device 102 can include a housing 902. In various embodiments, the housing 902 is adapted to be worn on or behind an ear of a wearer. The housing 902 is configured rest against a user's outer ear in a behind-the-ear orientation. The housing 902 can be manufactured utilizing any suitable technique or techniques, e.g., injection-molding, 3D printing, etc. The housing 902 can include any suitable material or materials, e.g., silicone, urethane, acrylates, flexible epoxy, acrylated urethane, and combinations thereof. In various embodiments, the housing can be formed from a top case 904 and a bottom case 906. In some embodiments, the top case 904 is removably attached to the bottom case by means of any of adhesive, a snap fit, press fit, a pin connection, or the like.

In various embodiments, the ear-worn device 102 can include input devices 105. In the example of FIG. 9, the input devices 105 are disposed on the top case 904 of the housing 902, but other placements are of the input device are possible. In various embodiments, the input device 105 can have include one or more, buttons, switches, or the like, such as a first button and a second button. For example, a volume up button and a volume down button can be included in the input device. In various embodiments the hearing aid user can interact with the input device 105 (e.g., by pressing one or more buttons) to adjust the volume, change one or more settings, or turn the ear-worn device on or off.

In various embodiments, the housing 902 can define an electronics cavity 903 between the top case 904 and the bottom case 906. The electronics cavity 903 can be configured to hold one or more electronic components. The electronic components can be disposed in any suitable location or arrangement within the electronics cavity 903. The ear-worn device 102 can include any suitable combination of electronic components as will be further described herein.

The ear-worn device 102 can further include an earbud 918 configured to be worn in the ear canal of the user. Any suitable earbud 918 can be utilized with the ear-worn device 102. In some examples, the earbud 918 can be a custom-fit earmold or a dome style earbud that does not block the entire ear canal opening of the wearer. The earbud 918 can be operatively connected to the electronic components housed in electronics cavity 903 using any suitable technique or techniques. The ear-worn device 102 can further include a cable 916 or connecting wire. The cable 916 can include one or more electrical conductors and provide electrical communication between components inside of the housing 902 and the earbud 918. In one or more embodiments, the earbud 918 can be operatively connected to the electronic components disposed within the housing by a cable 916 forming a sound tube that extends between the earpiece and the housing 902. The ear-worn device 102 shown in FIG. 9 is a behind-the-ear (BTE) type device and thus the receiver is designed to be placed within the ear canal. However, it will be appreciated that many different form factors for ear-worn devices are contemplated herein. As such, ear-worn devices herein can include, but are not limited to, behind-the-ear (BTE), in-the ear (ITE), in-the-canal (ITC), invisible-in-canal (IIC), receiver-in-canal (RIC), receiver in-the-ear (RITE) and completely-in-the-canal (CIC) type ear-worn devices. Aspects of ear-worn devices and functions thereof are described in U.S. Pat. No. 9,848,273; U.S. Publ. Pat. Appl. No. 2018/0317837; and U.S. Publ. Pat. Appl. No. 2018/0343527, the content of all of which is herein incorporated by reference in their entirety.

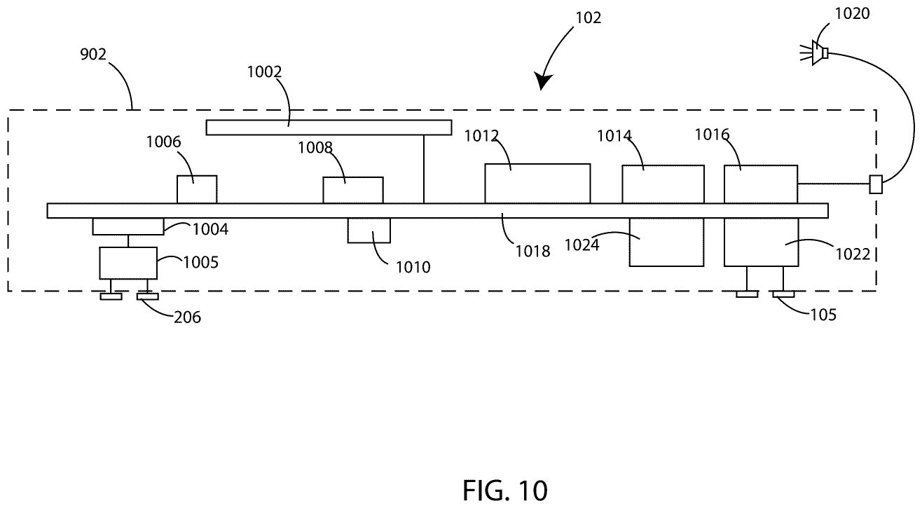

Referring now to FIG. 10, a schematic block diagram of an ear-worn device is shown with various components of an ear-worn device in accordance with various embodiments. The block diagram of FIG. 10 represents a generic ear-worn device for purposes of illustration. It will be appreciated that ear-worn devices herein can include a greater or lesser number of components than that shown in FIG. 10. The ear-worn device 102 shown in FIG. 10 includes several components electrically connected to a flexible mother circuit 1018 (e.g., flexible mother board) which is disposed within housing 902. A power supply circuit 1004 can include a battery and can be electrically connected to the flexible mother circuit 1018 and provides power to the various components of the ear-worn device 102. In some examples, the power supply circuit 1004 can include power supply that is different than a battery and which is electrically connected to the flexible mother circuit 1018 and provides power to the various components of the ear-worn device 102. A power supply circuit 1004 can include a battery 1005, can be electrically connected to the flexible mother circuit 1018, and provides power to the various components of the ear-worn device 102. One or more case charging structures 206 are connected to battery 1005 and are configured to interface with the case charging structure 206 of the charging case.

One or more microphones 1006 are operatively connected to the flexible mother circuit 1018, which provides electrical communication between the microphones 1006 and a digital signal processor (DSP) 812. Among other components, the DSP 1012 incorporates or is coupled to audio signal processing circuitry configured to implement various functions described herein. A sensor package 1014 can be coupled to the DSP 1012 via the flexible mother circuit 1018. The sensor package 1014 can include one or more different specific types of sensors. One or more user switches 1010 (e.g., on/off, volume, mic directional settings) can be operatively coupled to the DSP 1012 via the flexible mother circuit 1018.

An audio output device 1016 is operatively connected to the DSP 1012 via the flexible mother circuit 1018. In some embodiments, the audio output device 1016 comprises a speaker (coupled to an amplifier). In other embodiments, the audio output device 1016 comprises an amplifier coupled to an external receiver 1020 adapted for positioning within an ear of a wearer. The external receiver 1020 can include an electroacoustic transducer, speaker, or loudspeaker. The ear-worn device 102 may incorporate a wireless communication component 1008 coupled to the flexible mother circuit 1018 and to an antenna 1002 directly or indirectly via the flexible mother circuit 1018. The wireless communication component 1008 can be a BLUETOOTH® transceiver, such as a BLE (BLUETOOTH® low energy) transceiver or other transceiver (e.g., an IEEE 802.11 compliant device). The wireless communication component 1008 can be configured to communicate with one or more external devices, such as those discussed previously, in accordance with various embodiments. In various embodiments, the wireless communication component 1008 can be configured to communicate with the case 104, an external visual display device such as a mobile device, a smartphone, a video display screen, a tablet, a computer, a display projector, a virtual reality display, an augmented reality display, or the like.

In various embodiments, the ear-worn device 102 can also include a control circuit 1022 and a memory storage device 1024. The control circuit 1022 can be in electrical communication with other components of the device. The control circuit 1022 can execute various operations, such as those described herein. In some embodiments, the control circuit 1022 is electrically connected to the input device 105, such that the control circuit can process signals generated by the user input. Control circuit 1022 can include various components including, but not limited to, a microprocessor, a microcontroller, an FPGA (field-programmable gate array) processing device, an ASIC (application specific integrated circuit), or the like. The memory storage device 1024 can include both volatile and non-volatile memory. The memory storage device 1024 can include ROM, RAM, flash memory, EEPROM, SSD devices, NAND chips, and the like.

The memory storage device 1024 can be used to store data from sensors as described herein and/or processed data generated using data from sensors as described herein.

### Wireless Communication Devices

In various embodiments, the ear-worn device 102 may include a wireless communication component 1008 and case may include a case wireless communications device 858. Ear-worn devices of the present disclosure can be configured to receive streaming audio (e.g., digital audio data or files) from an electronic, electromagnetic, optical, or digital source. Ear-worn devices herein can also be configured to switch communication schemes to a long-range mode of operation, wherein, for example, one or more signal power outputs may be increased and data packet transmissions may be slowed or repeated to allow communication to occur over longer distances than during typical modes of operation. In some embodiments, a higher link margin can be achieved through various techniques including, but not limited to, increasing wireless signal power, coded modulation, and/or baseband coding. Representative electronic/digital sources (also serving as examples of accessory devices herein) include the case 104, an assistive listening system, a TV streamer, a radio, a smartphone, a cell phone/entertainment device (CPED), a phone streaming device, a telecoil receiver device, a pendant, wrist-worn device, a remote microphone, a remote control, a hearing instrument programming device, or other electronic device that serves as a source of digital audio data or files.

In various embodiments, the ear-worn device wireless communication component 1008 is configured to communicate with the case wireless communications device 858. For instance, the ear-worn device wireless communication component 1008 may send wireless signals to the case wireless communications device 858 for several purposes such as to change the operating mode of the case or to notify the case that a valid ear-worn device is in proximity for streaming or charging. Further, the case wireless communications device 858 may send wireless signals to the ear-worn device wireless communication component 1008 for several purposes including streaming audio to the ear-worn device.

In various embodiments, the ear-worn device wireless communication component 1008 and the case wireless communications device 858 are configured to operate at one or more compatible frequencies. The ear-worn device wireless communication component 1008 and the case wireless communications device 858 may operate at any suitable frequency or frequencies, including but not limited to frequencies of about 900 MHz, 2.4G, or 5G.

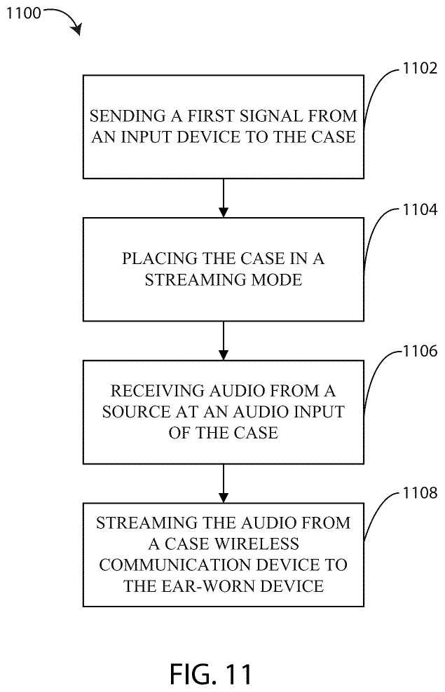

### Method of Using a Case (FIG. 11-14)

Referring now to FIG. 11, a method of streaming audio to an ear-worn device from a case is shown in accordance with various embodiments herein. First, the ear-worn device is paired with the case using the wireless communication devices in each component. Many different protocols can be used for pairing the two devices when they are in close proximity to each other, such as pushing an input device on the case and pushing an input device or a series of input devices on the ear-worn device. A communication protocol script is initiated in the firmware of each device to pair the ear-worn devices with the case.

The method 1100 can include the step 1102 of sending a first signal from an input device to the case. In various embodiments, a user may activate the input device to send the signal to the case 104 in a number of ways including, but not limited to pushing a button, flipping a switch, tapping a screen, speaking a vocal command, or the like.

The input device may be provided by one or more components of the hearing assistance system 100. In some embodiments, the input device may be incorporated into the ear worn device 102, such as the input device 105 depicted by FIGS. 1 and 9. In addition or alternatively, in some embodiments, the ear worn device 102 can detect a tapping motion by the user using an IMU, so that a tapping on the ear worn device 102 can provide an input and the IMU is an input device. In addition or alternatively, in some embodiments, the input device may incorporated into the case 104, such as the input device 626 depicted by FIG. 6. In addition or alternatively, in some embodiments, the input device is physically separate from both ear-worn devices and from the case. For instance, the input device may be a separate remote control, or can be incorporated into a smartphone or other computing device programmed to communicate wirelessly with the ear-worn device 102 and the case 104. In various embodiments, the hearing assistance system 100 may have multiple input devices each capable of sending the signal to the case 104. For instance, both the ear-worn device 102 and the case 104 may include input devices. Alternatively, the hearing assistance system 100 may include an input device on the ear-worn device, an input device on the case, an input device as a part of another device, or a combination of these.

In various embodiments, an input device can signal the ear-worn device, the case, or both to enter a scanning, pairing, or connection firmware routine to enable one device to wirelessly connect to the other device, or to set a communication protocol for the streaming. For example, pairing can be a BLUETOOTH® pairing process where devices are paired for two-way communication between the devices. In another example, scanning can include setting one or more signal characteristics, such as frequency, amplitude, and/or other characteristics, where the sending device is broadcasting and the receiving device is set to accept the information for one-way communication.

In various embodiments, an input device can be used to signal the ear-worn device, the case, or both to change into or through a series of preset modes. Examples of modes include a streaming mode, a non-streaming mode, a charging mode, and other modes. The input device can cycle through modes when the input device is activated. The input device can be state-based to change the mode from a first mode to a second mode, and back again, similar to an on-off switch. Alternatively, the input device can have a multipole setting where it can move the device from a first state to a second state to a third state.

The input device can have a button configuration where a push of the button creates an input signal. The input device can have a slide configuration and can slide between positions to enable the user to select between two, three, four, five, or more modes. The input device can have a rotary switch configuration and rotate to enable the user to select between positions that select between two, three, four, five, or more modes.

The method 1100 can include the step 1104 of, upon receiving the first signal, placing the case in a streaming mode. In various embodiments, the first signal is received wirelessly by the case 104 via the case wireless communications device 858. Alternatively, in embodiments where the input device is housed on the case 104, the first signal is received directly at the case processor disposed on the first circuit board 216 of the case.

The method 1100 can include the step 1106 of receiving audio from a source at an audio input of the case. In various embodiments, the input audio is received by the case 104 from a device electrically connected to the first interface port 622 or the second interface port 624. Any suitable device may be electrically connected to the first interface port 622 or the second interface port 624, including, but not limited to, an assistive listening system, a TV streamer, a radio, a smartphone, a cell phone/entertainment device (CPED), a phone streaming device, a telecoil receiver device, a pendant, a wrist-worn device, a remote microphone, a remote control, a hearing instrument programming device, or other electronic device that serves as a source of digital audio data or files.

Alternatively, the input audio is received by the case 104 via one or more microphones electrically connected to the first circuit board 216. The one or microphones may receive audio from any number of audio sources in the ambient environment proximate to the case 104.

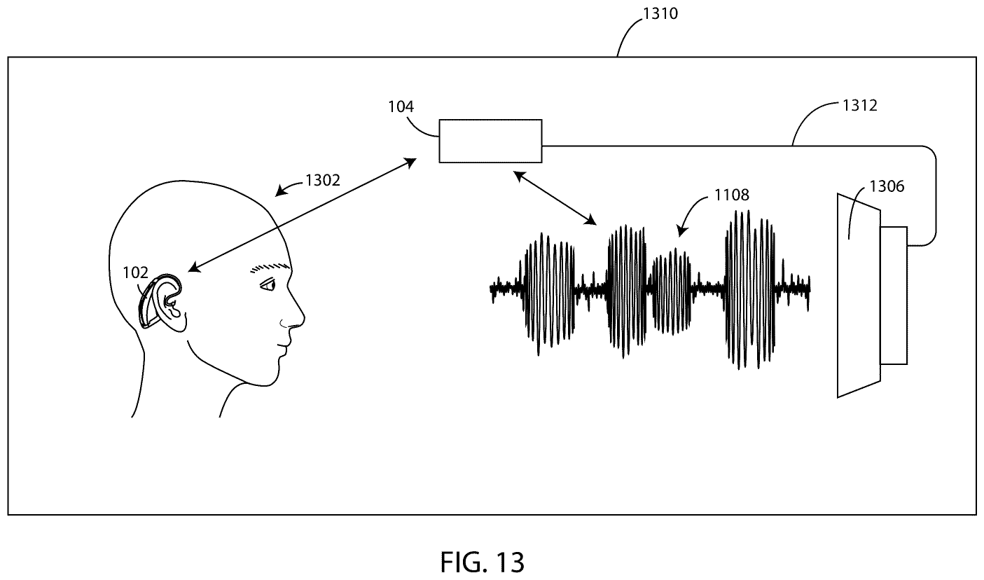

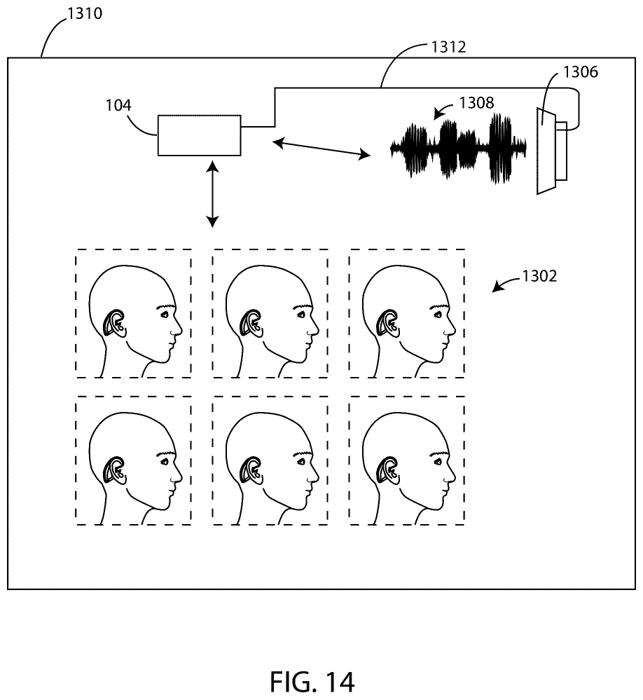

The method 1100 can include the step 1108 of streaming the audio from the case wireless communications device 858 to the device wireless communication component 1008 of one or more ear-worn devices 102. In some embodiments, as depicted by FIG. 13, the case may stream the audio to one or more ear-worn devices worn by a single user. In some embodiments, as depicted by FIG. 14, the case may stream the audio to one or more ear-worn devices worn by multiple users.

Referring now to FIG. 13, a schematic view is shown of an ear-worn device user 1302 within an environment 1310 in accordance with various embodiments herein. The environment 1310 can include an audio source 1306 emitting sound waves 1308. In some embodiments, the sound waves 1308 can be picked up by one or more microphones electrically connected to the case 104. In some embodiments, the audio source 1306 may be electrically connected to an interface port of the case 104 through electrical connection 1312 and the input audio is received by the case from the audio source electrically connected to the case interface port.

In some embodiments, the audio source 1306 can be in wireless communication with the case 104. The input audio is received by the case at a case wireless communication device. The case wireless communication device can operate at any suitable frequency or frequencies. In an embodiment, the case operates at any frequency available for public use such as 900 MHz, 2.4 GHz, 5 GHz, or other frequencies.

Upon receiving the input audio from the audio source 1306, the case wireless communication device is configured to stream the input audio to a wireless communication device of the ear-worn device 102.

The audio source 1306 may be an electronic/digital source. Representative electronic/digital sources (also serving as examples of accessory devices herein) include an assistive listening system, a TV streamer, a radio, a smartphone, a cell phone/entertainment device (CPED), a phone streaming device, a telecoil receiver device, a pendant, wrist-worn device, a remote microphone, a remote control, a hearing instrument programming device, or other electronic device that serves as a source of digital audio data or files. Alternatively, the audio source 1306 can be any other source of audio such as one or more people conversing within the environment 1310.

Referring now to FIG. 14, a schematic view is shown of a plurality of ear-worn device users 1302 within an environment 1310 in accordance with various embodiments herein. Similar to FIG. 13, the case 104 is configured to receive input audio from the audio source 1306 through any of a case interface port, case microphone, or case wireless communication device. However, in the embodiment of FIG. 13, the case 104 is configured to stream the input audio to ear-worn devices worn by multiple users 1302.

First, all users pair their ear-worn device or devices with the case using the wireless communication devices in each component. Upon receiving the input audio from the audio source 1306, the case wireless communication device is configured to stream the input audio to a wireless communication device of each ear-worn device 102 worn by each of the plurality of users 1302. In some embodiments, each user 1302 may be able to adjust the settings of their ear-worn device to selectively receive or opt out of receiving the audio stream from the case 104.

Many different methods are contemplated herein, including, but not limited to, methods of making, methods of using, and the like. Aspects of system/device operation described elsewhere herein can be performed as operations of one or more methods in accordance with various embodiments herein.

In various embodiments, operations described herein and method steps can be performed as part of a computer-implemented method executed by one or more processors of one or more computing devices. In various embodiments, operations described herein and method steps can be implemented computer instructions stored on a non-transitory, computer-readable medium that, when executed by one or more processors, cause a system to execute the operations and/or steps.

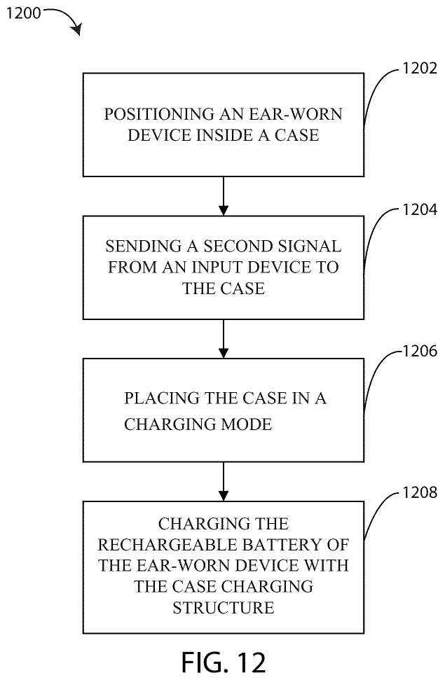

Referring now to FIG. 12, a method of charging an ear-worn device inside the case is shown in accordance with various embodiments herein. The method 1200 can include the step 1202 of positioning the ear-worn device inside the case such that the device charging structure is in electrical communication with the case charging structure. In some embodiments, step 1202 may further include closing a lid of the case such that one or more contact points interact with one another when the case is in the closed position to charge the ear-worn devices. Alternatively, the lid may be left open while the ear-worn devices are charged, or the case may not have a lid.

The method 1200 can include the step 1204 of sending a second signal from an input device to the case. The input device may be incorporated into the ear worn device, incorporated into the case 104, or be physically separate from the both first ear-worn device and from the case.

The method 1200 can include the step 1206 of, upon receiving a second signal from the input device, placing the case in a charging mode. In various embodiments, the case enters the charging mode only after receiving the second signal from the input device. In alternative embodiments, the case may enter the charging mode automatically upon sensing that one or more ear-worn devices have been positioned within the case. In various embodiments, the case is in a charging mode unless it has been placed in a streaming mode.

The method 1200 can include the step 1208 of charging the rechargeable battery of the ear-worn device with the case charging structure. In some embodiments, the case includes a conductive charging structure, and the ear-worn device is charged through direct physical and electrical contact with a charging structure of the case 104. Alternatively, the case 104 includes an inductive charging structure such that the ear-worn device is charged by being placed in proximity to a charging structure of the case 104.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A hearing assistance system comprising:
a first ear-worn device comprising a device speaker, a device microphone, a device processor, a device non-transitory computer memory, a device rechargeable battery, and a device wireless communication component;
a case configured to charge the device rechargeable battery of the first ear-worn device, the case comprising:
a first case charging structure for charging the device rechargeable battery of the first ear-worn device,
a case rechargeable battery,
a second case charging structure for charging the case rechargeable battery,
a case processor,
a case non-transitory computer memory,
a first case microphone,
a first case interface port; and
a case wireless communication device; and
the hearing assistance system further comprising an input device configured to provide an input signal to the case processor;
wherein the case non-transitory computer memory stores computer instructions for:
upon receiving a first signal from the input device, placing the case in a streaming mode, in which first input audio is received by the case and streamed from the case wireless communication device to the device wireless communication component of the first ear-worn device; and
placing the case in a charging mode, in which first ear-worn device is charged by the first case charging structure upon being received by the case.

2. The hearing assistance system of claim 1, wherein the first input audio is received by the case through the first case microphone.

3. The hearing assistance system of claim 1, wherein the first input audio is received by the case from a device electrically connected to the first case interface port.

4. The hearing assistance system of claim 3, wherein the second case charging structure comprises the first case interface port, wherein the first case interface port comprises electrical contacts for interfacing with a power supply to charge the case rechargeable battery.

5. The hearing assistance system of claim 4, wherein the case further comprises a second case interface port configured to receive the first input audio from an auxiliary device electrically connected to the second case interface port.

6. The hearing assistance system of claim 1, wherein the first input audio is received by the case wireless communication device from an auxiliary device.

7. The hearing assistance system of claim 1, wherein the first ear-worn device is configured to be worn by a first user, the hearing assistance system further comprising a second ear-worn device configured to be worn by a second user, wherein when the case is in the streaming mode, the first input audio is streamed from the case to the first ear-worn device and to the second ear-worn device.

8. The hearing assistance system of claim 1, the case comprising a streaming circuit board comprising the first case microphone and the first case interface port.

9. The hearing assistance system of claim 8, the case comprising a power circuit board, wherein the power circuit board is physically separate from the streaming circuit board, the power circuit board comprising the case battery and the case charging structure.

10. The hearing assistance system of claim 8, the streaming circuit board further comprising:
a front microphone disposed on a front portion of the streaming circuit board corresponding to a front side of the case;
a rear microphone disposed on a rear portion of the streaming circuit board corresponding to the rear side of the case;
a left microphone disposed on a left portion of the streaming circuit board corresponding to a left side of the case; and
a right microphone disposed on a right portion of the streaming circuit board corresponding to a right side of the case.

11. The hearing assistance system of claim 1, wherein the first ear-worn device further comprises the input device.

12. The hearing assistance system of claim 1, wherein the case further comprises the input device.

13. The hearing assistance system of claim 1, wherein the input device is physically separate from the first ear-worn device and from the case.

14. The hearing assistance system of claim 1, wherein the case wireless communication device communicates at a frequency of 900 MHz, 2.4G or 5G.

15. The hearing assistance system of claim 1, wherein the case wireless communication device is configured to communicate with a mobile device.

16. A hearing assistance system comprising:
a first ear-worn device comprising a device speaker, a device microphone, a device processor, a device non-transitory computer memory, a device rechargeable battery, and a device wireless communication component;
a case configured to charge the device rechargeable battery of the first ear-worn device, the case comprising:
a first case charging structure for charging the device rechargeable battery of the first ear-worn device,
a case rechargeable battery,
a second case charging structure for charging the case rechargeable battery,
a case processor,
a case non-transitory computer memory,
a first case microphone,
a first case interface port, and
a case wireless communication device; and
the hearing assistance system further comprising an input device configured to provide an input signal to the case processor;
wherein the case non-transitory computer memory stores computer instructions for:
upon receiving a first signal from the input device, placing the case in a streaming mode, in which first input audio is received by the case and streamed from the case wireless communication device to the device wireless communication component of the first ear-worn device; and
upon receiving a second signal from the input device, placing the case in a charging mode, in which first ear-worn device is charged by the first case charging structure upon being received by the case.

17. A method of streaming audio to an ear-worn device from a case, the ear-worn device comprising a device wireless communication device, a rechargeable battery, and a device charging structure and the case comprising a case wireless communication device, a case charging structure and a case rechargeable battery, the method comprising:
sending a first signal from an input device to the case;
upon receiving the first signal, placing the case in a streaming mode;
receiving audio from a source at an audio input of the case; and
streaming the audio from the case wireless communication device to the device wireless communication device.

18. The method of claim 17, wherein the ear-worn device is configured to be worn by a first user, the method further comprising streaming the audio from the case wireless communication device to a second device wireless communication device of a second ear-worn device configured to be worn by a second user.

19. The method of claim 17, further comprising:
positioning the ear-worn device inside the case such that the device charging structure is in electrical communication with the case charging structure;
sending a second signal from the input device to the case;
upon receiving a second signal from the input device, placing the case in a charging mode; and
charging the rechargeable battery of the ear-worn device with the case charging structure.

20. The method of claim 17, the audio input of the case comprising a microphone.
